(19) United States
(12) Patent Application Publication
(10) Pub. No.: US 2008/0140596 A1
(43) Pub. Date: Jun. 12, 2008

(54) Method of effective memorization

(76) Inventor: Rongfu Xiao, Fremont, CA (US)

Correspondence Address: Rongfu Xiao, 43305 Livormoro Common, Fremont, CA, 94539, US

(21) Appl. No.: 11/955,657

(22) Filed: Dec. 13, 2007

Related U.S. Application Data
(63) Continuation-in-part of application No. 10/906,995, filed on Mar. 15, 2005.

(51) Int. Cl. G06N 3/02

(52) U.S. Cl. 706/25

(57) ABSTRACT

This invention is about a method to enhance memory retention and its application to language learning and other learning processes that require memorization of old content learned in an earlier time. The method uses a memory retention function R˜t^{(d-D)} to iteratively calculate when next review (or repeat) is needed before the previously learned content is likely forgotten, where the R is percentage (%) of memory retention after a time span t, and d is a parameter relating to fractal dimension of the activated neurons participating in the learning process in human brain. This invention provides an effective way for students to learn a new language or to memorize new thing learned previously.

This application is a continuation-in-part of prior application Ser. No. 10/906,995 filed on Mar. 15, 2005, and claims the benefits of the prior application under 35 U.S.C. 120.

### BACKGROUND OF THE INVENTION

Memorization of what has been learned previously is important in every aspect in our daily life. Without a memory, our human being will not exist. Although the memory capability of our human being is much advanced than any other living beings, memory always decays. The earliest scientific observation of memory forgetting was made by German psychologist Herman Ebinghaus in 1885, according to whom, memory forgetting follows a logarithmic law. Since then, there have been many reports (see, for example, “One hundred years of forgetting: A quantitative description of retention”, D. C. Rubin & A. E. Wenzel, Psychological Review, 103, 734, 1996) about memory decay and on how to enhance memory retention. However, there have been quite few methods to effectively increase memory retention for language learning.

From microbiological point of view, our brain consists of billions of neurons, and the structure of neuron is fractal-like (FIG. 1). Memorization is actually a process of neuron activation and cross-linking. The more neurons get activated or cross-linked, the stronger and longer the memory retention will be.

### SUMMARY OF THE INVENTION

This invention discloses a method to design a memorization scheme to help people quickly memorize what they have seen or learned previously using a memory retention parameter R in a form of power law with respect to time t, i.e., R˜t^{(d-D)}. The invention relates memory retention to the fractal dimension d of the activated neurons participating in the memorization process in human brain. The more repeating, the more neurons will get activated (connected), which results in an increase in fractal dimension and memory retention. With this method, a personalized “just-right-time” reviewing process is formed and interactively adjusted (in terms of the parameter d) as user continues to learn new content. The method provides an effective way to learn a language or to memorize old things that otherwise will be forgotten.

### BRIEF DESCRIPTION OF THE DRAWINGS

FIG. 1 Schematic illustration of neuron activation under the influence of repeated information impulses. (a) Initial state: all neurons are inactive (idle); (b) An information impulse activates some neurons; (c) Repeated impulses activate more neurons, and cross-links between different neurons are established.

FIG. 2 Time dependence of memory retention with four different fractal dimensions for the activated neurons.

FIG. 3 Numerical result for four repeated memorization processes. A review is given before memory retention drops below a critical level as indicated by the horizontal line. Through a series of timely review, short-term memory gradually becomes long-term memory.

FIG. 4 Flow chart showing how the current invention is used to design an effective vocabulary-learning scheme. The locations marked by \textcircled{c} indicate re-calculation of next review time for the word that has been repeatedly seen.

FIG. 5 A real example showing time-dependence of repeated memorization process for English language learning for two users (User A and B). Vertical axis represents the word index under study, and horizontal axis is the time that the users actually spent to learn the listed words. Those “sudden drops” on the curve indicate a review of the old words learned previously.

### DETAILED DESCRIPTION OF THE INVENTION

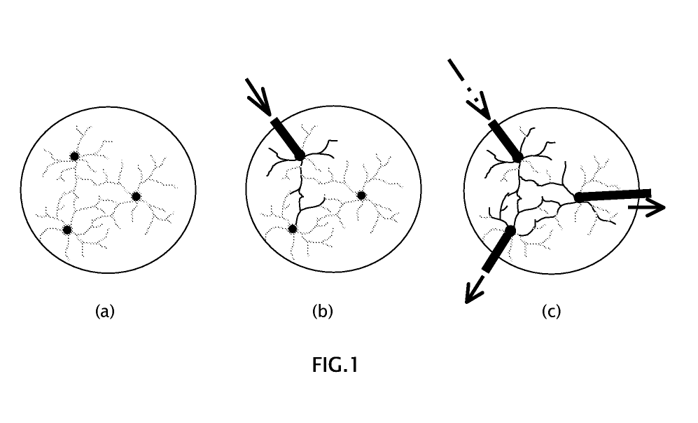

This invention relates the memory retention in language learning to the fractal dimension of neurons (FIG. 1) that actively participate in the learning process in human brain. The method is based on the activation of inactive neurons [FIG. 1(a)] by information impulse via human information sensors (namely ears, eyes and hands, etc). The impulse transmits the information from one neuron to another via their biological dendrite (see FIG. 1(b), more detailed activation involves synaptic transmission and action potential). Through repeated memory rehearsals, more neurons get connected (activated, see FIG. 1(c)), and the fractal dimension of the active neurons become larger and the memorization retention become stronger. From the statistic physics point of view, fractals in nature are self-similar and its physical properties scale with a power law, i.e. ˜L^{d} (see, for example, Introducing Fractal Geometry, 3^{rd} edition 2006, by Nigel Lesmoir-Gordon), where d is a fractal dimension and L is the size of the fractals considered. We believe fractals found in neurons in our brain should also follow a power law because their physical representation is the same as other fractals found in nature.

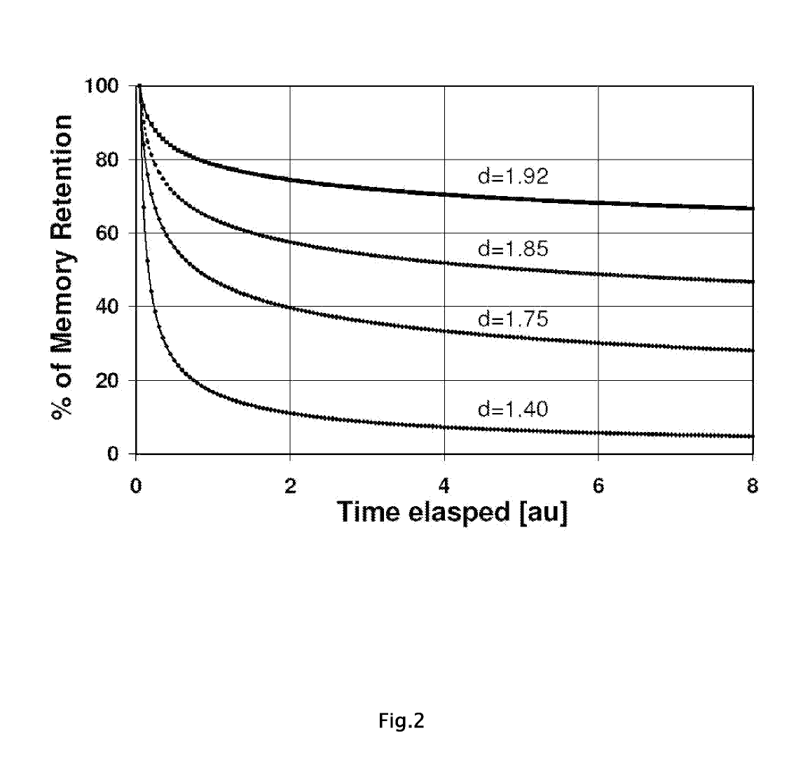

The result in FIG. 2 was obtained using time dependent power law R˜t^{(d-D)}, of R (percentage of memory retention) versus time t with four different fractal dimensions. As one can see from this figure that with increase of fractal dimension d, R becomes progressively larger, i.e., from short-term memory changes to long-term memory.

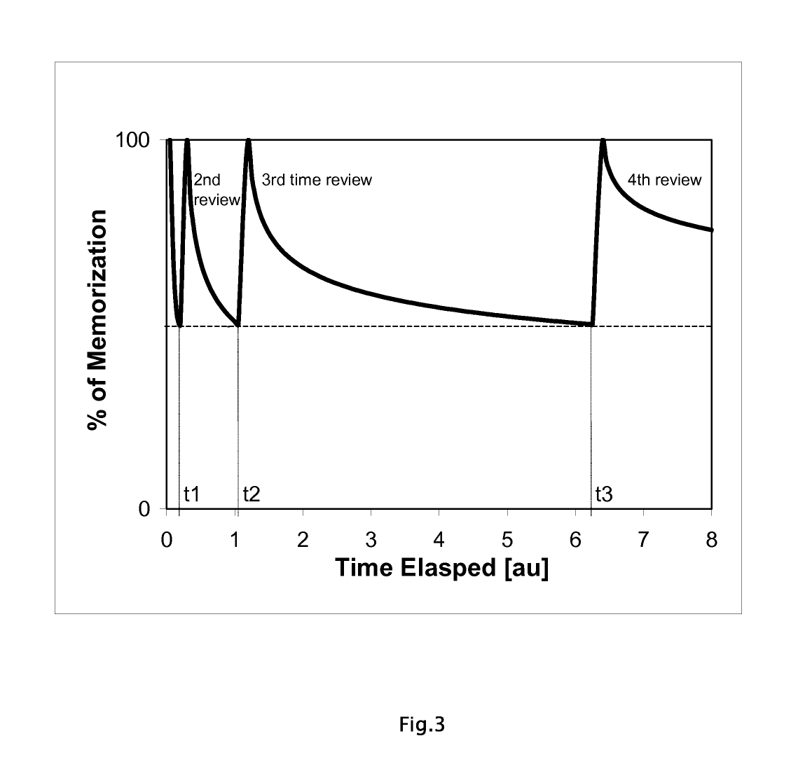

To remember longer and stronger, a timely review is a must-to-do requirement. FIG. 3 shows how a series of successive review improves memory retention. After the first study, the memory retention is very short and the information just learned is quickly lost. However, as the number of review increases, more and more neurons get connected [see FIG. 1(c)], resulting larger fractal dimension. As the result, memory retention ability becomes better and stronger. There is a critical reviewing time beyond which majority of memory will be lost. Such a critical time is calculated based on a statistical median between completely forgotten and fully memorized. The horizontal line in FIG. 3 indicates such a critical moment that triggers the next review. Once the memorization R drops below this value, next review will be given immediately. A too-short or too-long review will be either unnecessary (a waste of time) or too late to prevent what has been learned from being lost. An alternative way to determine such a critical reviewing time is by Monte Carlo simulation during the learning process based on each user's response for any specific object (such as, a new English word).

### AN EMBODIMENT OF THE INVENTION

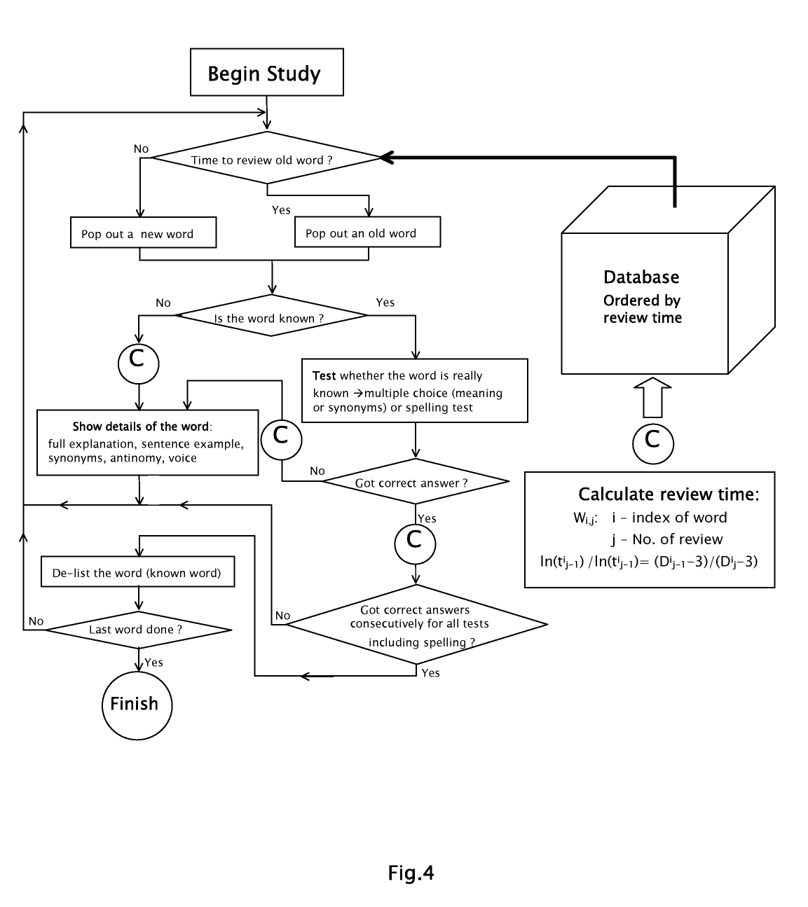

The memorization retention for different people is very different, and different for different subject or new word even for the same person. To illustrate the effectiveness of this method, computer software was designed to help people to quickly learn a language. FIG. 4 is a flow chart illustrating the logical paths for the design of a computer program used to effectively memorize a set of new (such as English) words. When a word pops up from a computer screen, the software will immediately calculate the next review time based on the user's response (i.e., known or unknown) and the previous review time for each individual word. If the user knows the word, a test (one out of three) will be given, otherwise (i.e., unknown) a full explanation (fully utilize all sensory elements of human being) will be provided. The fractal dimension d is constantly updated and revised from the review time calculation. The vocabulary learning process is seamlessly integrated with each user's reaction to each word that he or she is studying. The “hard words” (i.e., difficult to memorize) will have more frequent (i.e., shorter) time to review while those “easy words” will be reviewed less frequently (longer time span between each review). The hard words will keep come out from time to time until they are fully memorized (i.e., not forget even over years) by the user. The computer is constantly checking whether any old word needs to review. The priority will be given to review old word. A new word comes out only when there is no old words need to review at that time.

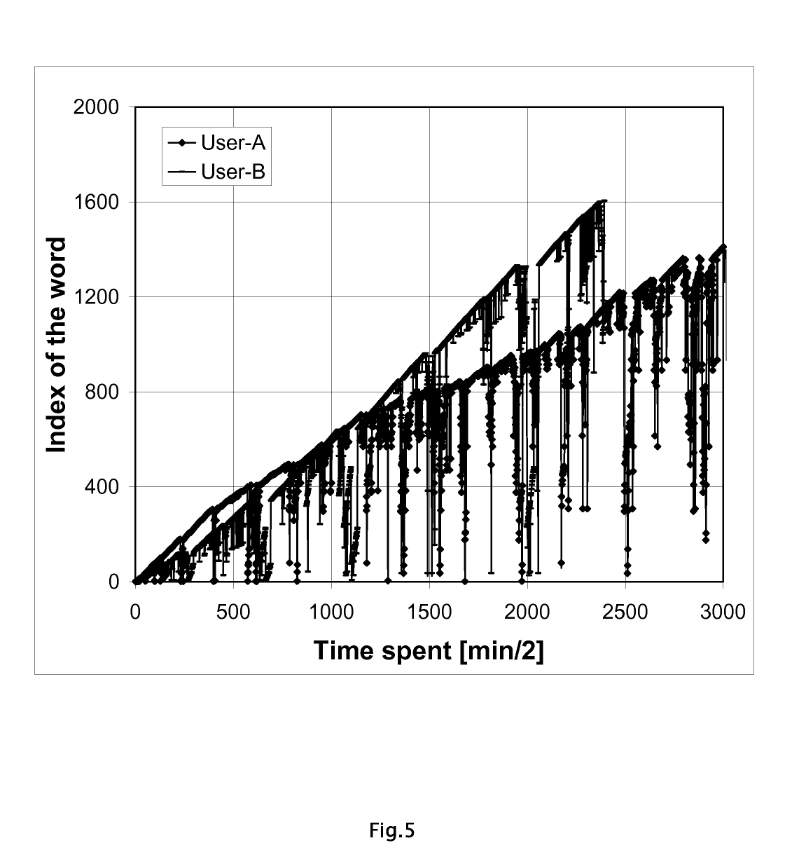

FIG. 5 shows an actual result using our above-mentioned memory retention review scheme for two users in a real English vocabulary memorization process. The vertical axis represents the word index and horizontal scale is the actual time spent in this vocabulary memorization process. A sudden “drop” in this figure indicates a review of the old word before beginning to learn next new_word. As can be seen from this figure, User-B has memorized 1600 new English words in 1200 minutes (accumulated net study time), while User-A has spent 1500 minutes (25 hours) and just learned 1400 words. Also, the word reviewing sequence for these two users was very different. To remember the same amount of words, User-A took much more time in reviewing the old words. The memory retention capability for User-B is much better than User-A, indicating more active neurons participating in the learning process in User-B's mind than User-A. Thus, the language learning process must be treated separately for different user.

What is claimed is:

1. An effective memorization method, comprising:
a computer program to simulate memory retention in a human's brain, using:
a formulae R˜t^{(d-D)} to iteratively calculate the percentage of memorization, where R represents memory retention ability, and t is a time span after a review and is chosen in such a way that the memory is about to forget the content that previously learned.

2. The d described in claim-1 is related to fractal dimension of activated neurons in a human's brain and D is a geometric dimension of either 2 or 3, and d is increased by repeated reviewing.

3. The memorization method according to claim-1 can be used for any language learning, or any training process that requires memorization of the old content learned in an earlier time.
